(19) United States
(12) Patent Application Publication
(10) Pub. No.: US 2024/0039282 A1
(43) Pub. Date: Feb. 1, 2024

(54) RENEWABLE/SUSTAINABLE ENERGY HARVESTING AND MONETIZATION ECOSYSTEM

(71) Applicant: The North Bethesda Portfolio LLC, North Bethesda, MD (US)

(72) Inventors: Sean Geoffrey O'Sullivan, North Bethesda, MD (US); Timothy Brian Hennessey, Pottstown, PA (US); Timothy Francis Hennessey, Pottstown, PA (US); Jennifer A. Kruger, South Bend, IN (US); Daniel Liam Glennon, Elkins Park, PA (US)

(21) Appl. No.: 18/362,943

(22) Filed: Jul. 31, 2023

Related U.S. Application Data
(60) Provisional application No. 63/513,438, filed on Jul. 13, 2023.
(60) Provisional application No. 63/393,379, filed on Jul. 29, 2022.

(51) Int. Cl. H02J 3/14; H02J 3/32; G06Q 20/36; G06Q 20/38

(52) U.S. Cl. CPC H02J 3/14; H02J 3/322; G06Q 20/36; G06Q 20/389; H02J 2300/24; H02J 2300/28

(57) ABSTRACT

A sustainable and compact green energy harvesting, storage and monetization ecosystem. Various energy capturing devices (e.g., solar, wind, water, kinetic) are utilized to capture sustainable and renewable energy that is captured in portable energy storage devices (e.g., battery packs). The energy from the battery packs is collected by an energy collection, storage and distribution facility that may store the energy for future use and/or utilize the energy to mine/purchase cryptocurrencies, provide energy for industry, provide charging stations, and/or sell energy back to the grid. Customers are paid for the energy they provide in various types of currencies based on their contract with the system. The ecosystem is small, sustainable, green, scalable, environmentally friendly, and easy to use for anyone, anywhere.

### PRIORITY

This application claims the priority under 35 U.S.C. § 119 of U.S. Provisional Patent Application 63/393,379 filed on Jul. 29, 2022 and U.S. Provisional Patent Application 63/513,438 filed on Jul. 13, 2023. Applications 63/393,379 and 63/513,438 are incorporated herein by reference in their entirety.

### BACKGROUND

Sustainable and renewable energy, so called “green” energy, has become more popular as a means to provide energy without harming the environment. However, green energy is not really an option for individuals, neighborhoods, organizations, or communities. Other than solar panels on your roof that can be used to power items in your house and to provide any excess back to the electric grid, there are few real options. This also requires installation of the solar panels and connection to the electric grid.

Digital assets, Web3.0, Regenerative Capitalism, and cryptocurrency have also become more popular as a form of currency, asset storage, community building and transactions. Mining cryptocurrency utilizes a large amount of energy. Accordingly, large scale cryptocurrency mining operations cannot be performed by individuals, neighborhoods, companies, organizations or communities who cannot afford the energy bills that would be associated therewith. Furthermore, large scale cryptocurrency mining operations are typically not powered using green energy. Accordingly, large scale cryptocurrency mining operations have created a potential problem with unsustainable energy use and greenhouse gases.

In order to provide green energy for large scale cryptocurrency mining operations giant hydro, wind or solar powerplants may be required. Bitcoin, Litecoin and other cryptocurrency mining companies may be capable of building and operating such large green powerplants. However, individuals, neighborhoods, other companies and organizations and communities are not able to afford the expense that would be required to create and/or operate a green power plant capable of providing sufficient green energy to perform cryptocurrency mining operations.

The companies operating the crypto mining systems too often create problems in communities by contributing to unsustainable energy issues. Furthermore, the output generated by these companies is not generally distributed to the individuals who are most in need of economic growth.

What is needed is a system that can enable individuals, neighborhoods, organizations, companies and communities the ability to more easily generate green energy and have that green energy monetized. Furthermore, what is needed is the ability to enable the individuals, neighborhoods, organizations, companies and communities generating the green energy to select the manner in which they monetize their green energy, including receiving cryptocurrency, credits or cash.

### BRIEF DESCRIPTION OF DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 illustrates a high-level example process flow for an example green energy harvesting and monetization ecosystem, according to one embodiment;

FIG. 2 illustrates a perspective view of an example small footprint water turbine connected to a gutter downspout, according to one embodiment;

FIG. 3 illustrates a functional diagram of an example battery pack to be used in the system, according to one embodiment;

FIG. 4 illustrates an example installation of several energy collection devices and an energy storage device at a customer's residence, according to one embodiment;

FIGS. 5A-G illustrate an example installation of solar panels and battery packs on various different vehicles in order to harvest green energy, according to various embodiments;

FIG. 6 illustrates a front view of an example tractor trailer having wind turbines mounted thereto, according to one embodiment;

FIG. 7A illustrates an example flow of battery backs between customers, local exchange facility and regional energy storage and distribution facility, according to one embodiment;

FIG. 7B illustrates an example flow of energy from battery packs used by customers to a transfer facility and then to a regional energy storage and distribution facility, according to one embodiment;

FIG. 8 illustrates an example depot parking and storage lot for tractor trailers that provides cables for discharging the battery packs of the tractor trailers, according to one embodiment;

FIG. 9 illustrates an example functional diagram of a regional energy collection facility, according to one embodiment;

FIG. 10 illustrates a functional block diagram of a green energy harvesting, storage and monetization ecosystem, according to one embodiment; and

FIGS. 11A-B illustrate example views of a user interface provided by the mobile device application for the system, according to various embodiments.

### DETAILED DESCRIPTION

An ecosystem for enabling individuals, neighborhoods, organizations, companies and communities (“customers”) to harvest sustainable and renewable (“green”) energy without the need for a large investment and to be able to monetize the green energy in different fashions. The green energy may be collected in various manners (e.g., solar, wind, water). The green energy may be stored in energy storage devices (e.g., batteries). The customers establish digital asset storage “wallets” with the system and the customers energy storage devices are encoded to their “wallet”. The energy storage devices may transfer the energy stored therein to bigger energy collection facilities. The bigger energy collection facilities may use the energy for a multitude of purposes. For example, the energy could be utilized to power various industries, provide back to the power grid, power vehicle charging stations, store the energy for future use at potentially higher prices, or to mine or purchase crypto currencies. Regardless of how the energy is used, the system pays those providing the energy for the energy they provide. The payments from the system may be in the form of, for example, cash, energy credits, cryptocurrency, other commodities or a combination thereof.

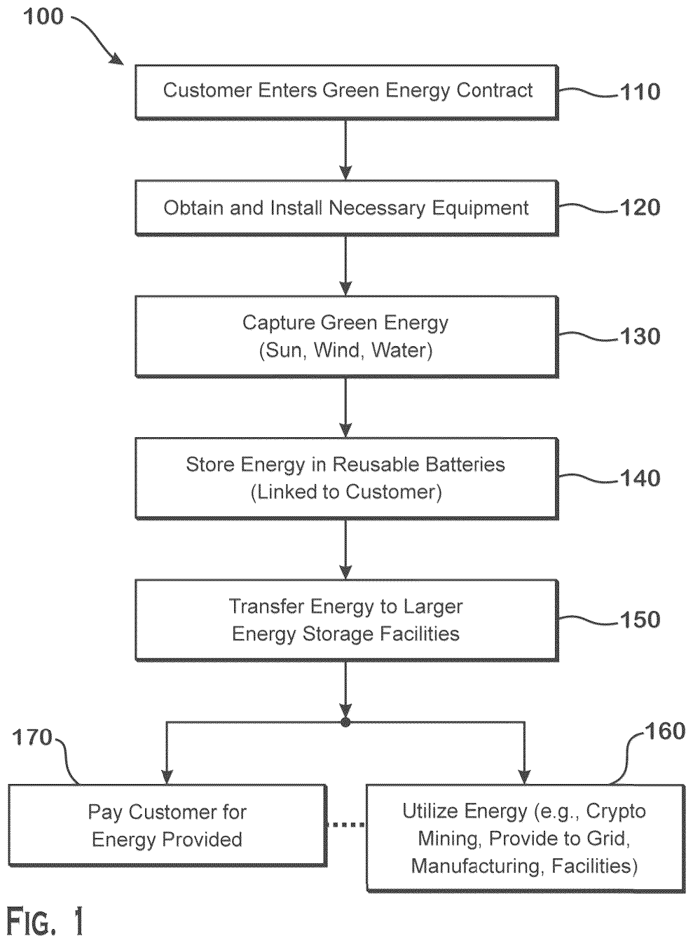

FIG. 1 illustrates an example high-level process flow 100 for an example green energy harvesting and monetization ecosystem. The process flow 100 starts when a customer enters a green energy contract (e.g., blockchain smart contract) with an entity operating the system (system operator) 110. The contract between the customer and the system operator may define various parameters including purchase, rental or financing of equipment necessary for collecting green energy (e.g., green energy capturing devices, green energy storage devices) and the payments to be received for providing the green energy. The contract may define how payment is to be received as payment may be received in cash, cryptocurrencies, credits or other commodities. Part of the contract is the creation of a blockchain/crypto currency wallet unique to the customer. The wallet tracks the equipment associated with the customer including green energy storage devise(s) so that the customer can be paid for energy captured therein by the customer. The wallet tracks the energy captured by the customer's equipment (e.g., kilowatt hours captured) and the transfer (e.g., exchange, upload) of the energy to the system. Furthermore, the wallet tracks the assets (e.g., cash, cryptocurrencies, credits, other commodities) that the customer has received for the energy they transferred to the system.

The customer downloads an application (e.g., iOS, Android, Windows) associated with the system onto a wireless device (e.g., smart phone) that they can use to access their wallet to track their assets and associate equipment (e.g., energy storage devices) they are using to their wallet. The application may be capable of associating equipment with the wallet by using a smart phone to scan a code (e.g., QR code) on the customer's equipment (to be discussed in more detail later). The customer may also create an account with the system that they can use to log into the system to access their wallet. The application and the system log in may also provide the customer with information regarding various trends associated with energy and cryptocurrency prices and projections therefore. According to one embodiment, the projections of the futures markets for crypto currencies and energy may be made based on artificial intelligence (AI) processing of previous markets for crypto currencies and energy, trends associated therewith, and current parameters (e.g., economic, political, social, calendar).

The contract may be updatable in real time to enable parameters to be changed. For example, the manner in which a customer is paid, may be toggled between various choices so that the customer can capture maximum value across energy prices, cryptocurrency prices, future credits analysis, energy storage dynamics, et. al. The toggling of the manner in which the customer is paid, may be made by the customer as they deem appropriate. That decision may be made based on the trending information provided by the system and/or on their own research. Alternatively, the customer may authorize the system to toggle the payment method based on projections generated by the AI, operators of the system, or third parties with expertise in futures markets. As would be understood, the customer would have to accept the risk associated with the system toggling to a payment option where the customer ended up losing money. The toggling feature will be described in more detail later.

Once the contract is entered, the customer obtains and installs the equipment necessary for collecting green energy 120. The equipment may include green energy capturing devices (e.g., solar panels, wind turbines, water turbines) and green energy storage devices (e.g., batteries). The equipment may be provided by the system operator or entities working with the system operator. The equipment may be purchased, rented, or financed. The equipment may be paid for at least partially based on the green energy captured by the customer and provided to the system. The equipment may be provided by the entity operating the system. However, the equipment need not be provided by the system so long as it can be integrated with the system. The green energy capturing devices and the green energy storage devices will be discussed in more detail later.

After the green energy capturing devices and the green energy storage devices are installed, the green energy capturing devices may begin to capture green energy 130. The energy may be captured via the different energy capturing devices mounted to stationary objects or moveable items. The energy captured is then stored in portable energy storage units (e.g., portable battery packs) 140. Once the battery pack reaches its capacity (or close thereto), the energy may be transferred to a larger energy collection facility 150. The energy may be transferred in various manners that will be described in more detail later. The energy may be utilized by a larger energy collection facility 160 in various manners including, but not limited to, operations thereof, providing back to the grid, industrial applications, charging electric vehicles, storing the energy for future use at potentially higher prices, or mining cryptocurrency. The use of the energy will be described in more detail later. The customers will be paid for the energy that they collect and provide to the system 170. The customer may be paid in various manners including, but limited to, cash, crypto currency, energy credits, crypto currency credits, and other commodities. The customer may toggle the form of payment that they receive. The payment of the customer is associated with the price associated with the use of the energy (e.g., current energy prices, amount of energy provided if payment is an energy credit, current crypto currency prices. The payment to the customer will be described in more detail later.

The green energy capturing devices may include, for example, solar panels, wind turbines, water turbines and other devices capable of capturing kinetic energy (e.g., mechanical motion). The green energy capturing devices may come in various configurations (e.g., size, shape, orientation, arrangement). The green energy capturing devices may be mounted to permanent locations (e.g., roofs, fields, streams) or may be mounted to moveable objects (e.g., vehicles including but not limited to cars, vans, trucks, buses, trains, light-rail, ships, airplanes, military vehicles, emergency vehicles). The green energy capturing devices may be capable of easily being installed by the customer or may require a professional installer. If a professional installer is required, the customer may pay for the cost of the installer or the cost may be financed as part of the smart contract in a fashion similar to the cost of the equipment as described above.

For example, solar panels may be capable of being mounted to structures such as a roof of a house, building or shed, or in the ground such as in the yard of a house or in a field. The size, shape and configuration of the solar panels may vary based on the structure they are located on or the amount of land available for their placement. The solar panels may be capable of being mounted to moveable objects (e.g., vehicles including but not limited to cars, vans, trucks, buses, trains, light-rail, ships, airplanes, military vehicles, emergency vehicles). The solar panels could be located on the roofs or potentially other areas (e.g., wind flaps, air foils) of the vehicles that may be subjected to sunlight. The use of solar panels on vehicles is currently an unharvested market for the collection of solar energy.

In order for solar panels to be used on moving vehicles they must be secured in such a fashion as to be able to handle the air flow passing thereover or therearound and not become dislodged. Furthermore, the solar panels cannot interfere with the performance of the vehicles (e.g., interfere with the drivers view, interfere with other vehicles that are in close proximity to the vehicle, change the footprint enough that it falls outside of defined standards). The solar panels may be flexible solar panels that can match the contour of the vehicle they are located on. The size, shape and configuration of the solar panels may vary based on the vehicle they are located on.

The attachment of the solar panels to the vehicles may include permanently mounting the solar panels to the vehicle or using some type of system that enables the solar panels to be removed. For example, the permanent mounting may include, but is not limited to, physically bolting the solar panels to the vehicle and using an industrial adhesive or glue to physically secure the solar panels thereto. Systems that may enable the solar panels to be removed may include, but are not limited to, mounting a roof-rack type system to the vehicle and securing the solar panels therewithin. The attachment of the solar panels to the vehicles is not intended to be limited to any specific mounting technique. Rather various methodologies that provide a safe and secure connection capable of handling wind-flow and motion are within the current scope.

Water turbines may be placed in areas where water is constantly running such as bodies of water like rivers and streams so long as they do not affect the overall flow of the water or wildlife living in the water. The water turbines may also be located in areas where the flow of water is controlled such as dams. Furthermore, the water turbines may be located in wastewater lines of high rises/skyscrapers to capture the kinetic gravitational energy of piped wastewater. Moreover, the water turbines may be located in locations where water runoff occurs during, for example, excessive precipitation. For example, water turbines may be located in, or at an exit point of, gutters, sluiceways or the like that carry water. During times of excess rain, the flow of water in the gutters may be sufficient to turn the blades of the turbine in order to generate energy. According to one embodiment, the water turbine may be located external to the path of the water flow out of the down spout of the gutters and be clamped to the gutters. The use of water turbines, specifically water turbines (e.g., small footprint) to utilize the flow of excess water that occurs during certain times is an unharvested source of energy.

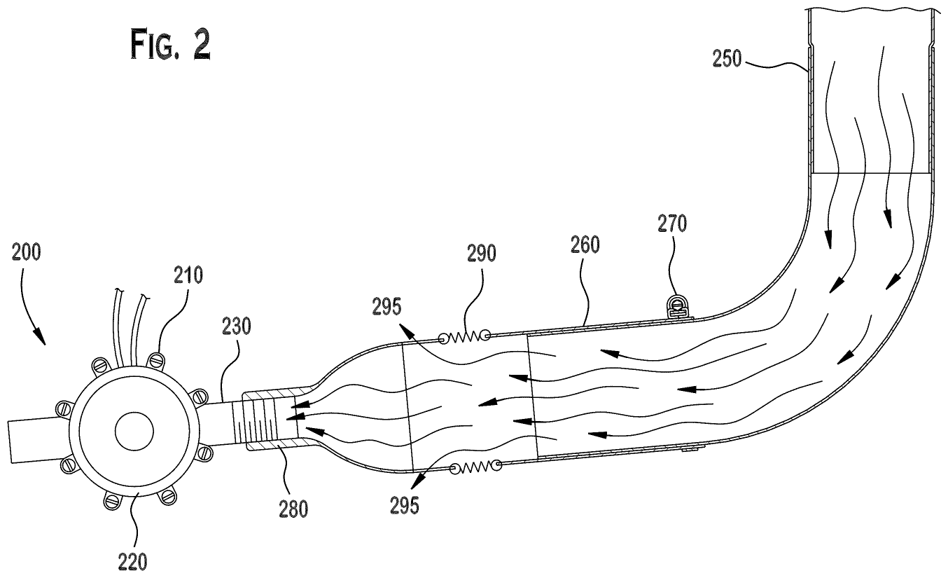

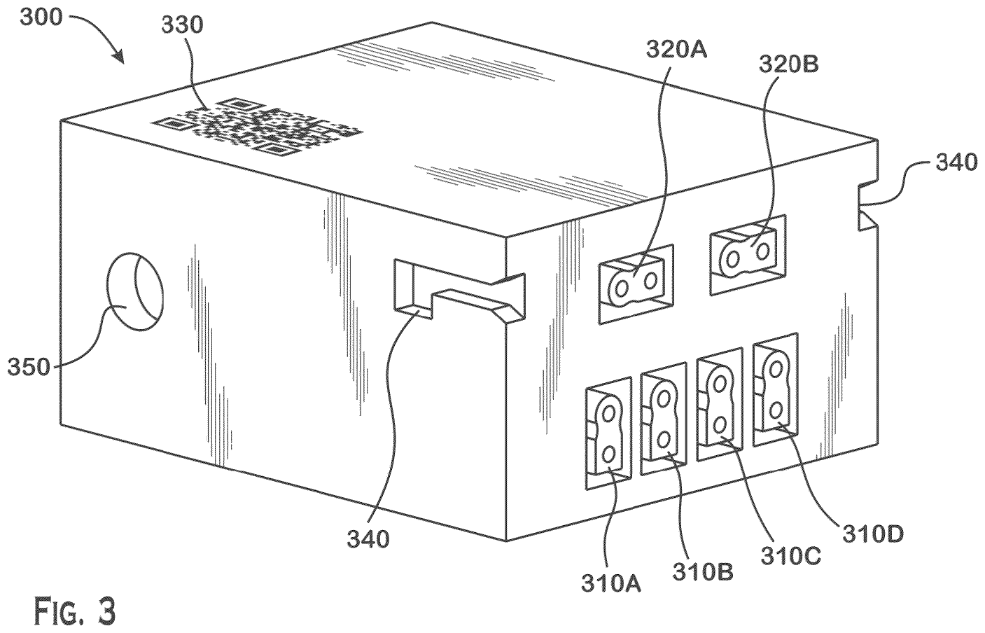

FIG. 2 illustrates a perspective view of an example small footprint water turbine 200 connected to a gutter downspout 250. The water turbine 200 includes a plurality of blades, buckets, or the like 210 mounted on a rotor 220. The blades 210 receive the water flowing from the downspout 250 and cause the rotor 220 to rotate. The rotation of the rotor 220 (mechanical energy) is converted to electric energy in a generator (not illustrated and not discussed herein). The turbine 200 may include an inlet 230 and an outlet 240. The inlet 230 is to receive the water and provide it to the blades 210 and the outlet 240 is to allow the water to exit the turbine 200.

The water turbine 200 is secured to the downspout 250 so as to not become dislodged and not to impact the water flow in some manner (e.g., slow water flow so water backs up in gutters, route the water flow to an undesired location). A housing 260 is placed over the downspout 250 and is clamped thereon with an adjustable clamp 270. The adjustable clamp 270 may be located at the bend of the downspout 250. An opposite end of the housing 260 may include a funnel 280 to narrow the flow of water exiting therefrom. The funnel 280 may be connected to the inlet 230 of the turbine 200. According to one embodiment, the funnel 280 and the inlet 230 may be threaded to secure them together. The housing 260 may include flexible tension springs 290 that enable the housing 260 to compress or extend as required. When no water is flowing the springs 280 may be compressed so that the funnel 280 abuts the downspout 250. When water is flowing the springs 280 may be expanded to reduce the tension between the downspout 250 and the turbine 200 in order to ensure the turbine 200 is not dislodged. The expanded housing 260 may also act as an overflow for excess water 295 to escape therefrom.

Wind turbines may be located in various locations where wind may be free to flow. The wind turbines may be mounted to permanent locations (e.g., fields, roofs, antennas) or may be mounted to moveable objects (e.g., vehicles including but not limited to cars, trucks, buses, trains, light-rail). The wind turbines on the moveable objects may be able to capture energy from the air flowing over/around the vehicle. The wind turbines could be located on the roofs of the various vehicles or potentially other areas (e.g., wind flaps, sides, fairings) of the vehicle. In order for wind turbines to be used on moving vehicles they must be secured in such a fashion as to be able to able to handle the air flow passing therethrough and not become dislodged. Furthermore, the wind turbines cannot interfere with the performance of the vehicles (e.g., change in air flow, change in height or width so as not be able to fit through certain locations). The size, shape and configuration of the wind turbines may vary based on the vehicle they are located on. The use of the airflow over and around moving vehicles is currently an unharvested market for the collection of wind energy.

The green energy storage devices may be portable devices that can be easily moved. The portable green energy storage devices may be moved to different locations in order to capture energy from different devices and may be exchanged for empty replacements when they are filled. The green energy storage devices may be batteries. Various different types of batteries may be utilized including, but not limited to, lithium ion, alkaline, carbon zinc, silver oxide, and zinc air. The batteries or other portable energy storage devices may come in a compact pack. For ease of discussion, the portable energy storage devices will simply be referred to as battery packs, but is not limited to any specific battery or even a battery. Rather, any compact and portable energy storage device now known or later discovered will fall within the scope. For example, a small-scale flywheel device could be utilized as a portable energy storage device without departing from the current scope. The battery packs may be located in close proximity to the green energy capturing devices (e.g., solar panels, wind turbines, water turbines, regenerative braking). The battery packs may be waterproof, weather resistant (e.g., handle hot and cold conditions), sturdy and tamper resistant. The battery packs may include some type of locking feature if they are mounted in a location that is not secure (e.g., located in a field, secured to a side of a vehicle).

The battery packs may be designed to work with, and capture energy from, various energy capturing devices (e.g., solar panels, wind turbines, water turbines, kinetic sources). The battery packs may connect to, and receive energy from, one energy capturing device at a time or multiple energy capturing devices at a time. The battery pack may include one or more ports, wherein each port is capable of receiving a cable from an energy capturing device to provide the connection therebetween and enable the energy captured to be stored therein. The battery packs may also include a port capable of receiving a cable from an energy collection device to extract the energy therefrom. The energy collection devices will be discussed in more detail later. According to one embodiment, the connections between the energy capturing devices, the battery packs and the energy collection devices may be based on a proprietary interface to ensure appropriate devices are utilized. According to one embodiment, a standard interface may be used so that various energy storage devices, battery packs and energy collection devices could be utilized.

The battery packs may be placed in a location where one or more energy collection devices connect thereto in order to provide the energy thereto. Alternatively, the battery pack may switch locations based on the one or more energy collection devices it desires to be connected to. For example, a battery pack may initially be used with solar panels on a moving vehicle and then when the vehicle is parked and a rainstorm is occurring the battery pack may be relocated to be used with a water turbine used in a downspout. The battery packs may store energy until the battery reaches its capacity. The battery packs may simply be capable of receiving energy from the energy collection devices and transferring the energy to energy collection devices and not providing energy to power other devices.

An identification of the battery pack is linked with the customer in the system (e.g., the identification may be included in the smart contract). The linkage of the battery packs to the customer in the system ensures that the battery packs can only be used by a registered customer and that the appropriate customer receives credit for the energy stored therein when it is transferred to another entity (e.g., larger energy capturing device) for the other entity to use in some fashion. The identification for the battery pack may be, for example, a QR code that can be easily scanned using a mobile device (e.g., smart phone) or coding in the battery electronics connected to a smart phone (e.g., iOS, Android, Windows) application or other system application including direct interaction with the smart contract. The customer may utilize an application on their mobile device (e.g., smart phone) for interacting with the system. The application may be used to link the battery pack to the customer. The application may also be utilized to track the charging status of the battery pack. The application may also be utilized to track the shipment of the battery pack and/or energy back to an energy collection facility and payment for the energy provided (to be discussed in more detail later).

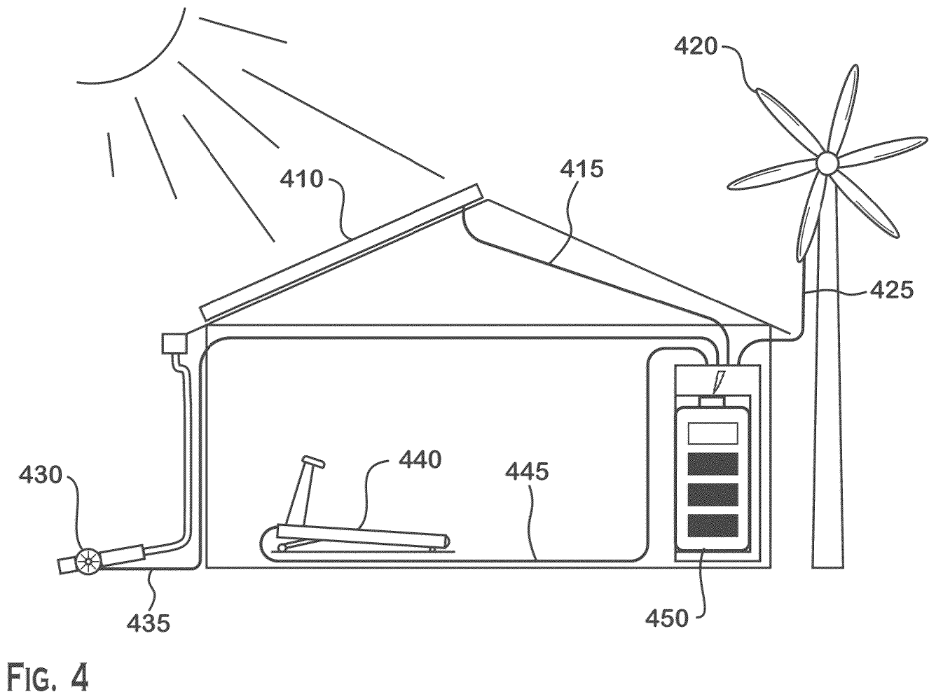

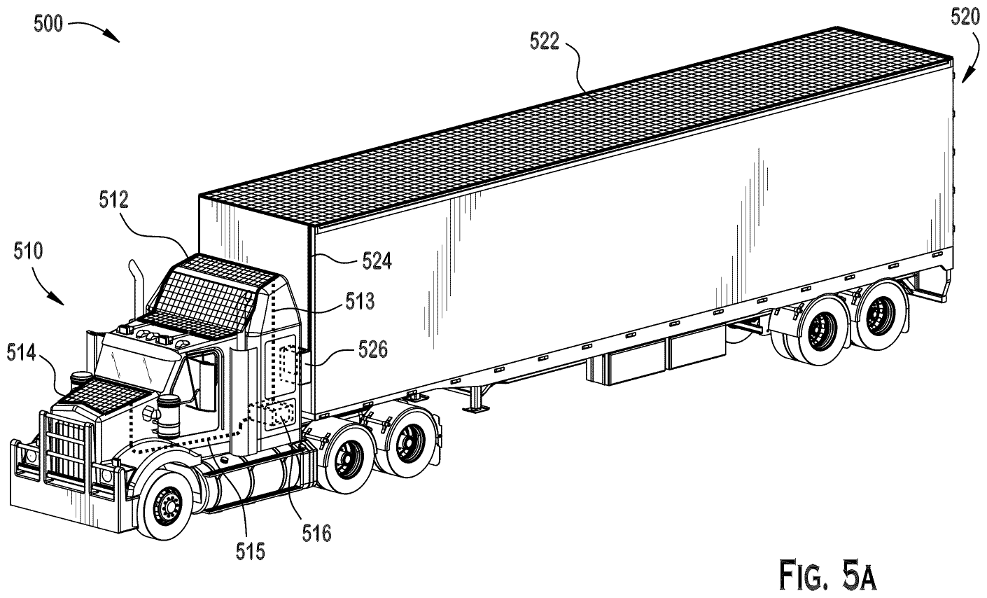

FIG. 3 illustrates an example perspective view of an example battery pack 300 to be used in the system. The battery pack 300 includes one or more input ports 310 (four ports 310A, 310B, 310C, 310D are illustrated) to receive energy from various energy capturing devices (e.g., solar panels, wind turbines, water turbines, kinetic source). The battery pack 300 also includes one or more output ports 320 (two ports 320A, 320B are illustrated) to enable the energy stored therein to be extracted therefrom. The different output ports 320A, 320B may be associated with different levels of charging (or discharging). For example, port 320A may be level 2 discharging and port 320B may be level 3 discharging. The battery pack 300 includes a unique identification 330 that can be utilized to identify battery pack 300 in the system and associate the battery pack 300 with the customer that is utilizing it to store energy. The unique identification 330 may be, for example, a QR code that is scanned using an application on a customer's smart phone. The battery pack 300 may include receptacles 340 for securing the battery pack within, for example, a charger case. The receptacles 340 are illustrated as being indents in the side of the battery pack 300 but are not limited thereto. For example, the receptacles 340 could be protrusions received within channels in a charger case without departing from the current scope. The battery pack 300 may include a locking mechanism 350 to enable the battery pack 300 to be locked in place. As illustrated, the locking mechanism 350 is a receptacle for receiving a security lock but is not limited thereto. For example, the locking mechanism 350 could be, for example, a lockable clip capable of securing to an item or may be a port capable of receiving a cable that is wrapped around an item without departing from the current scope. The battery pack 300 may be contained within a weatherproof housing so that it can be located outside without impacting the operation thereof.

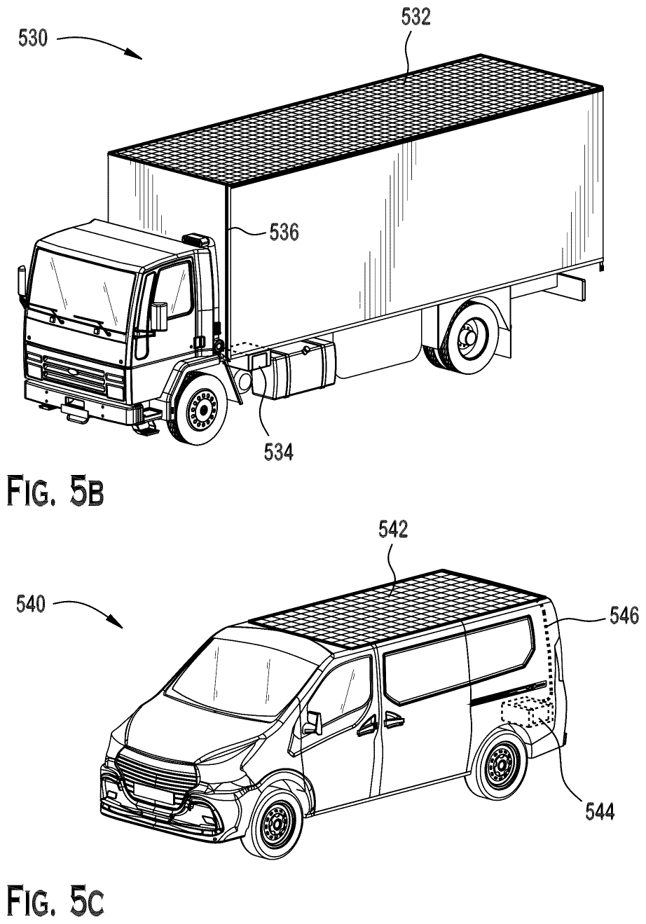

FIG. 4 illustrates an example installation of several energy collection devices and an energy storage device at a customer's residence. The installation includes a solar panel 410 on the roof of a house, a wind turbine 420 installed on a post in the yard (a windmill), a water turbine 430 installed in at least one of the downspouts and a treadmill 440 for capturing kinetic energy. Each of these energy collection devices 410-440 is connected to a port in a battery pack 450 via a respective cable 415-445. The battery pack 450 is mounted to a wall of the residence. It should be noted that the FIG. 4 is not drawn to scale. As illustrated, the battery pack 450 is approximately 75% charged. It should be noted that the size of a wind turbine 420 may be limited in residential areas. As such, wind turbines such as the windmill illustrated may be prohibited. Accordingly, more efficient models of wind turbines (e.g., vertical axis helix wind turbine) may be utilized or smaller windmill type wind turbines (e.g., fans) may be linked in sequence and the sequence may be connected to the battery pack 450. It should also be noted that other devices (e.g., water turbines) may be hooked together in sequence as well and the sequence may be connected to the battery pack 450.

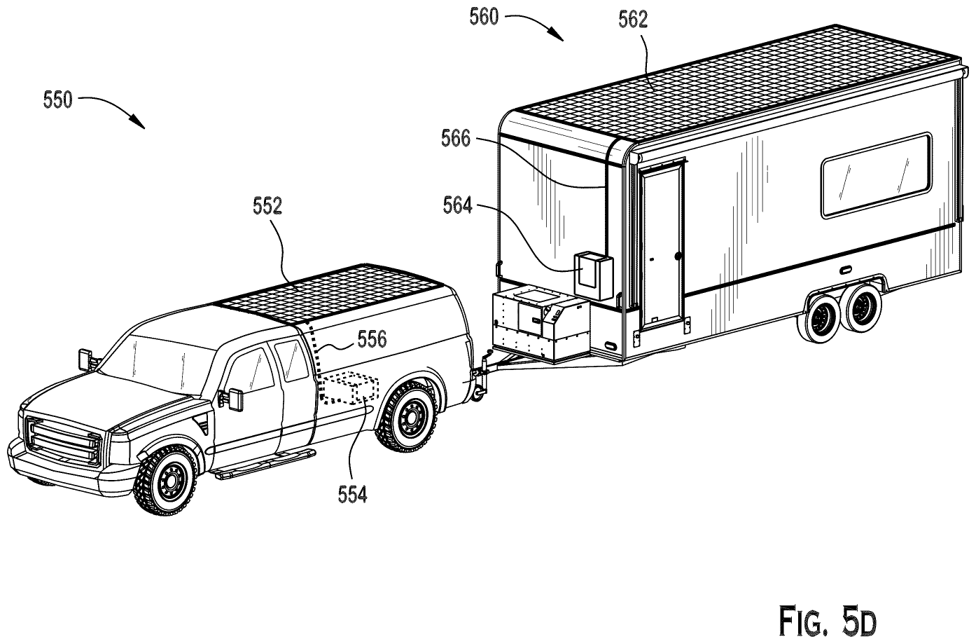

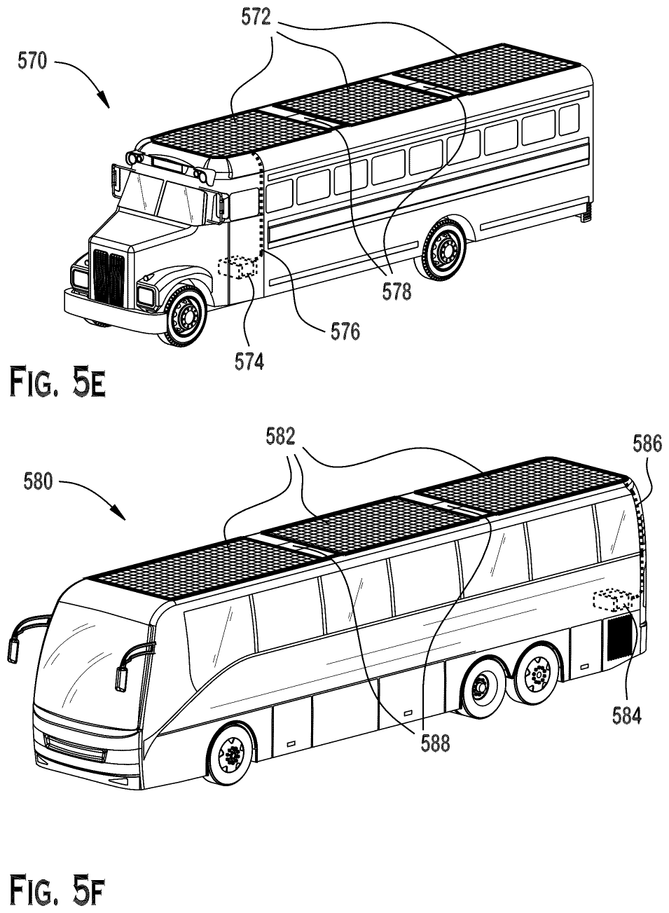

FIGS. 5A-G illustrate perspective views of an example installation of solar panels and battery packs on various different vehicles in order to harvest green energy. As previously discussed, the solar panels may be secured to the vehicles using, for example, bolts, an industrial adhesive or some type of mounting system. FIG. 5A illustrates a tractor trailer 500 including a cab 510 and a trailer 520. The cab 510 may include a solar panel 512 mounted on a wind flap and a solar panel 514 mounted on a hood. The cab 510 may include a battery pack 516 either mounted thereto (e.g., back of the cab 510 between the cab 510 and trailer 520) or located therewithin. The solar panels 512, 514 may be connected to the battery pack 516 via cables 513, 515. The trailer 520 may include one or more solar panels 522 mounted to a roof thereof. The solar panel(s) are illustrated as covering the whole roof but are not limited thereto. A battery pack 526 may be mounted to the trailer 520 and connected to the solar panels 522 via one or more cables 524. The battery pack 526 is illustrated as being mounted to a front of the trailer 520 between the trailer 520 and the cab 510 but is not limited thereto. For example, the battery pack 526 could be mounted to the back of the trailer 520 or beneath the trailer 520 without departing from the current scope. According to one embodiment, one or more of the battery packs 516, 526 could be housed in a case or receptable that is mounted to the cab 510 or trailer 520 respectively. The case/receptacle could be used to secure (e.g., lock) the battery pack therewithin. According to one embodiment, the battery pack 526 may be located within the trailer 520.

Separate battery packs for the cab and trailer 516, 526 enable energy to continue to be collected from each individually if the cab 510 and trailer 520 were separated. Furthermore, if a first battery pack (e.g., 516) was filled before a second battery pack (e.g., 526) when the cab 510 and trailer 520 are connected, the solar panels (e.g., 512, 514) associated with the first battery pack could be plugged into the second battery pack to allow for continued collection. According to one embodiment, a single battery pack could be used for both without departing from the current scope. The single battery pack could be located between the cab 510 and trailer 520 so the solar panels for each could easily be connected thereto.

Tractor trailers 500 create an enormous amount of heat when their diesel engines are running for hours at a time during, for example interstate travels. According to one embodiment, the heat from the engine can be transformed to energy (e.g., heat may cause mechanical movement which can then be converted to energy) and the generated energy may be provided by the battery pack 516.

FIG. 5B illustrates a box truck 530 having one or more solar panels 532 mounted to a roof of the trailer thereof. The box truck 530 includes a battery pack 534 for storing the energy and is connected to the solar panel(s) 532 via one or more cables 536. The battery pack is illustrated as being mounted beneath a front end of the trailer portion of the truck but is in no way intended to be limited thereto. The battery pack 534 could be mounted in various other locations (e.g., front of trailer above cab, rear of trailer, within trailer, below other portions of trailer) without departing from the current scope. The box truck 530 could include a case/receptacle mounted thereto that receives the battery pack 534 and secures/locks the battery pack 534 in place. The solar panel(s) 532 are illustrated as covering the whole roof but are not limited thereto. Furthermore, solar panels could be located on other portions of the box truck (e.g., top of cab) without departing the current scope.

FIG. 5C illustrates a van 540 having one or more solar panels 542 mounted to a roof thereof. The solar panel(s) 542 are illustrated as covering the whole roof but are not limited thereto. Furthermore, solar panels could be located on other portions of the van 540 (e.g., hood) without departing the current scope. The van 540 includes a battery pack 544 for storing the energy and is connected to the solar panel(s) 542 via one or more cables 546. The battery pack 544 is illustrated as being located within the van. The battery pack 544 may be located in a case/receptacle located therewithin. The battery pack 544 could be located in various other locations without departing from the current scope.

FIG. 5D illustrates a pickup truck 550 pulling a trailer 560 where each one has one or more solar panels 552, 562 mounted to a roof thereof. The truck 550 includes a battery pack 554 for storing the energy and is connected to the solar panel(s) 552 via one or more cables 556. The battery pack 554 is illustrated as being located within the truck 550. The battery pack 554 may be located in a case/receptacle located therewithin. The battery pack 554 could be located in various other locations without departing from the current scope. The trailer 560 includes a battery pack 564 for storing the energy and is connected to the solar panel(s) 562 via one or more cables 566. The battery pack 564 is illustrated as being mounted to a front of the trailer 560 but is in way intended to be limited thereto. The battery pack 564 may be located in a case/receptacle mounted to the trailer 560.

FIG. 5E illustrates a school bus 570 having solar panels 572 mounted to a roof thereof. The solar panels 572 are mounted so as to not cover escape hatches 578 in the roof. The school bus 570 includes a battery pack 574 for storing the energy and is connected to the solar panel(s) 542 via one or more cables 576. The battery pack 574 is illustrated as being located within the school bus 570 (near the driver) but is not limited thereto. The battery pack 574 may be secured within a case/receptacle.

FIG. 5F illustrates a passenger bus 580 having solar panels 582 mounted to a roof thereof, a battery pack 584 for storing the energy, and one or more cables 586 for connecting the solar panel(s) 582 and the battery pack 584. The solar panels 582 are mounted so as to not cover escape hatches 588 in the roof. The battery pack 584 is illustrated as being located within the passenger bus 580 (near rear) but is not limited thereto. The battery pack 584 may be secured within a case/receptacle.

FIG. 5G illustrates a train having one or more box cars 590 with two or more solar panels 592, 594 mounted to a roof thereof (one solar panel on each side of a center walkway), a battery pack 596 for storing the energy, and two or more cables 593, 595 for connecting the solar panel(s) 592, 594 and the battery pack 596. The battery pack 596 is illustrated as being mounted to a front of the box car 590 (bottom right side) but is not limited thereto. The battery pack 596 may be secured within a case/receptacle that is mounted to the box car 590.

According to one embodiment, the train may have one or more box cars 590 that have large energy storage devices (e.g., batteries) located therein instead of cargo. The solar panels 592, 594 from many, if not all, box cars and any other energy capturing devices that may be located thereon (e.g., wind turbines) can be provided to the one or more box cars containing batteries. The use of large energy storage devices (e.g., batteries) instead of individual battery packs makes the transfer of the energy from the train much simpler. For example, when a battery car is full, or nearly full, it can simply be exchanged for an empty battery car at a train yard, train depot, or some other facility located along the tracks.

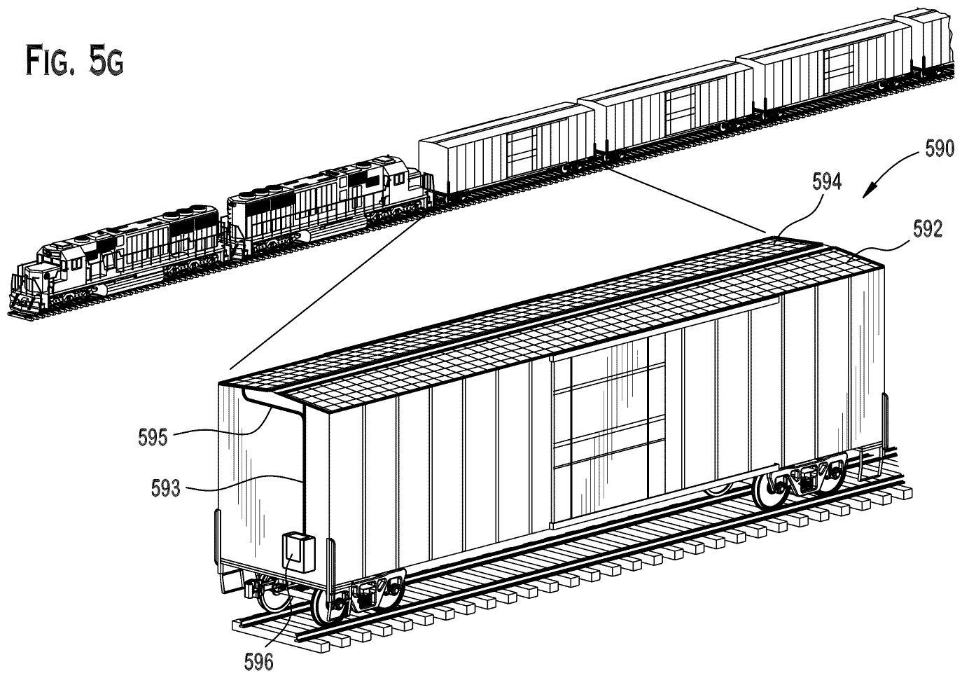

FIG. 6 illustrates a front view of an example tractor trailer 600 having wind turbines mounted thereto. As illustrated, wind turbines 610 are mounted on the side view mirrors and wind turbines 620 are mounted to sides of the wind flap. It should be noted that the wind turbines 610, 620 may be formed in the side view mirrors and the wind flap. The tractor trailer 600 is also illustrated as having solar panels 630 mounted to the hood and solar panels 640 mounted to the wind flap. While not illustrated, the tractor trailer 600 includes a battery pack and cables connecting the wind turbines 610, 620 and solar panels 630, 640 to the battery pack.

According to one embodiment, a user may swap a full (or nearly full) battery pack for an uncharged battery pack. The user may have the battery pack swapped at the location where the battery pack is in use (a vehicle may bring a new battery pack and take the charged battery pack) or may take the battery pack to an exchange location (drop off charged battery pack and take uncharged battery pack). The battery pack swap is the opposite of a propane tank swap where you exchange empty for full. The vehicles used to swap full battery packs for empty battery backs may be green/sustainable energy-powered electric vehicles (e.g., cars, trucks, drones).

The exchange facility receiving full batteries from, and providing empty batteries to, the customers may provide service to a limited geographic region (a local facility). The exchange facility may be associated with a neighborhood, a town, a city, a company, a store, or an industrial complex or other local site. Several exchange facilities may provide full battery packs to, and receive empty battery packs from, a regional facility. The regional facility may be for large scale energy storage and distribution thereof (to be discussed in more detail later).

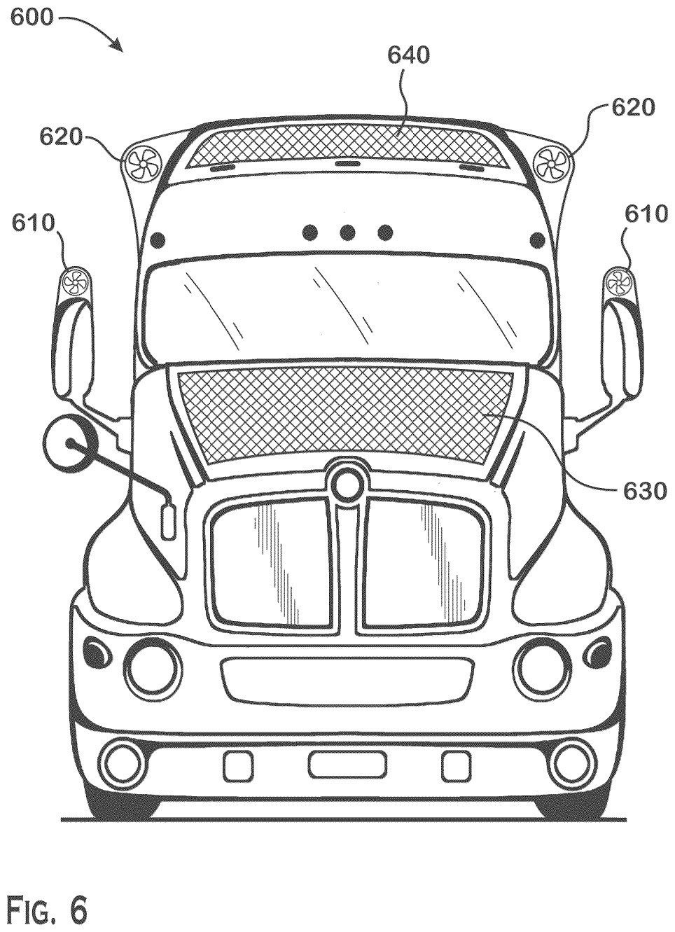

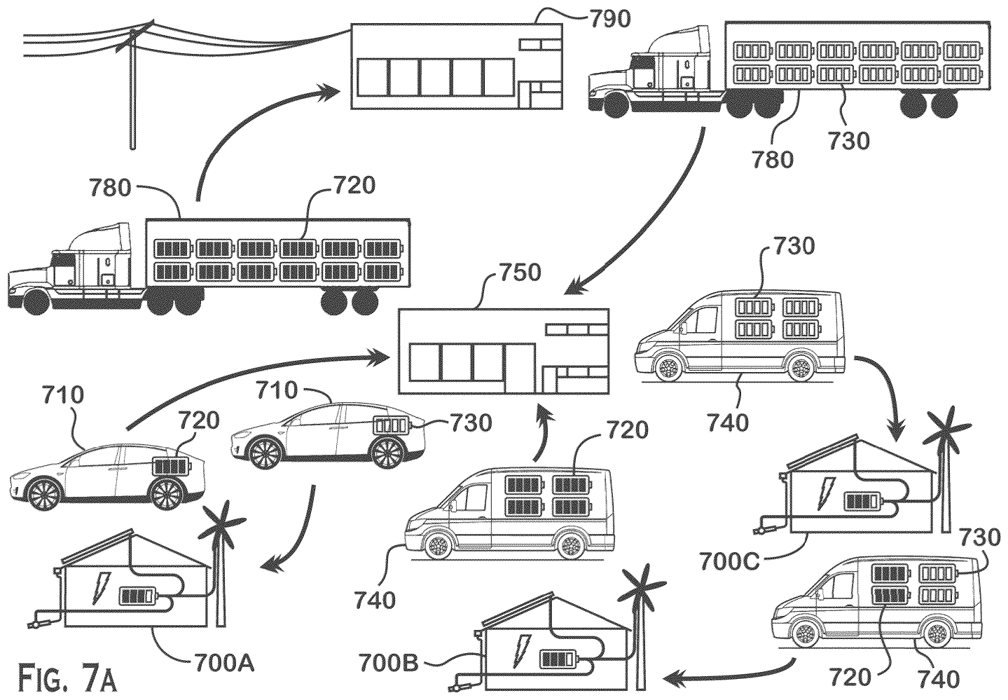

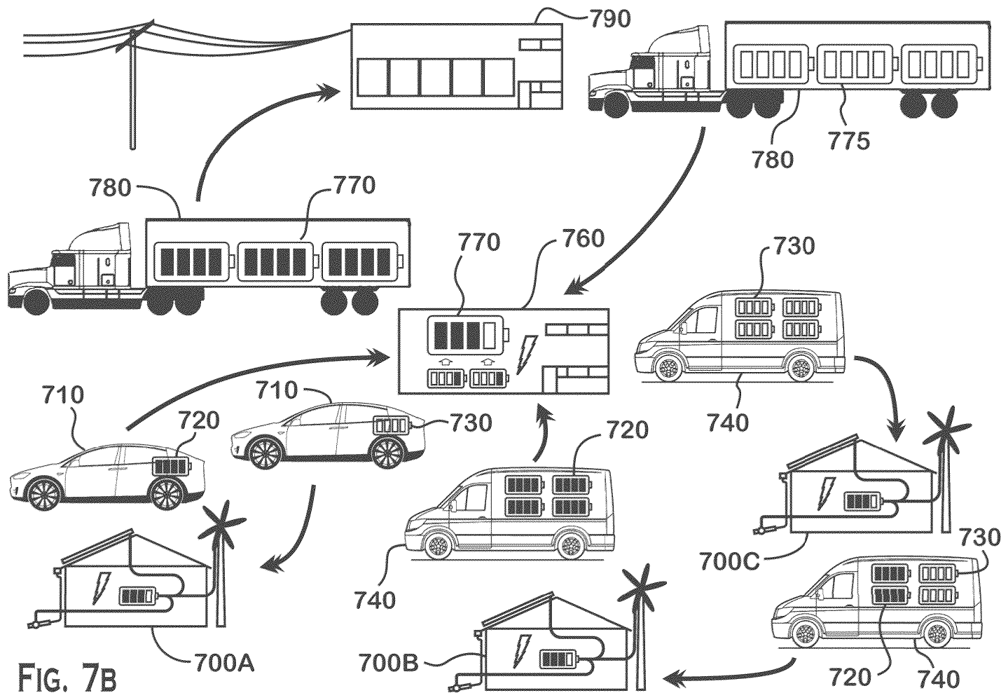

FIG. 7A illustrates an example flow of battery backs between customers 700, local exchange facility 750 and regional energy storage and distribution facility 790. As illustrated, each of the customers (three illustrated 700A, 700B, 700C) is a residence harvesting energy from a plurality of energy capturing devices (e.g., wind, solar and water) but is in no way intended to be limited thereto. When a customer has a full, or near full, battery pack an exchange may be initiated. The application may track the charging status of the battery pack and notify the customer when an exchange should be initiated. The first customer 700A may use their own transportation (e.g., car) 710 to exchange the battery pack. They take the full battery pack 720 to the local exchange facility 750 where they turn in their full battery pack 720 and receive an empty battery pack 730. The empty battery pack 730 is connected to the energy capturing devices so that it can begin to store energy being captured. The second and third customers 700B, 700C may utilize a remote exchange program where the battery packs are exchanged at the location they are used (e.g., at the residence). The customers 700B, 700C notify the system when their battery packs are full, or nearly full, and the system sends an exchange vehicle 740 to drop off an empty battery pack 730 and retrieve the full battery pack 720. The application may automatically notify the system when an exchange should be initiated. The exchange vehicle 740 may exchange battery packs at multiple locations and bring full battery packs from multiple locations back to the exchange facility 750. The exchange vehicle 740 may be a green/sustainable energy-powered electric vehicles. The exchange vehicle 740 may be, for example, a car, van, or truck at this point in time. However, in the future drones or other forms of transportation could be utilized.

The exchange facility 750 may collect the full battery packs 720 from customers and then deliver a large quantity of full battery packs 720 to the regional facility 790. The delivery to the regional facility 790 may be at defined intervals or may be once the exchange facility 750 reaches a certain capacity. A larger transport vehicle 780 may utilized to transport the full battery packs 720 from the exchange facility 750 to the regional facility 790 and transport empty battery packs 730 from the regional facility 790 to the exchange facility 750. The larger transport vehicle 780 is illustrated as a tractor trailer but is in no way limited thereto. Rather the larger transport vehicle 780 could be any type of larger vehicle driven on the road, a freight train, a cargo plane or a combination of various vehicles without departing the current scope. The larger vehicles 780 may collect full battery packs 720 from, and deliver empty battery packs 730 to, more than one local exchange facility 750. The larger vehicles 780 may be electric or otherwise green/sustainable energy powered.

The regional facility 790 may be a warehouse for storing the full battery packs 720 and/or may collect energy in large green energy collection and storage devices. The regional facility 790 may extract the energy from the full battery packs 720 into the large energy collection/storage devices. The regional facility 790 may utilize the energy captured in the large energy collection/storage devices for various purposes. The manner in which the energy stored in large energy collection/storage devices, including a regional facility 790, is utilized will be discussed in more detail later.

According to one embodiment, rather than exchanging full battery packs 720 for empty battery packs 730, the full battery packs 720 may have the energy stored therein extracted therefrom. The energy may be transferred by plugging the battery pack into an energy collection/storage device (e.g., a larger energy storage device) that extracts the energy from the battery pack. The transfer of the energy may take place at an energy transfer facility (e.g., depot, parking facility, storage facility, gas station, rest area) that accepts and stores the energy on site. The transfer facility may be associated with a neighborhood, a town, a city, a company, a store, or an industrial complex or other local site. The transfer facility may utilize some of the energy stored therein and may provide some of the energy to a regional facility (large scale energy storage and distribution facility).

FIG. 7B illustrates an example flow of energy from battery packs used by customers 700 to a transfer facility 760 and then to a regional energy storage and distribution facility 790. The flow diagram is similar to the flow diagram of FIG. 7A so like items are identified with the same reference numbers. The full battery packs 720 are provided to the transfer facility 760 either via the customers own transportation 710 or via an exchange vehicle 740. The full battery packs 720 are drained into larger energy collection/storage devices (e.g., batteries) 770 and then the empty battery packs 730 are provided back to the customer. According to one embodiment, the full battery packs 720 may be exchanged for empty battery packs 730 in real time and the full battery packs 720 may be drained at a later time.

The transfer facility 760 may transfer the full larger energy storage devices 770 to the regional facility 790 in a larger transport vehicle 780. The regional facility 790 may transfer empty larger energy storage devices 775 to transfer facility 760 in a larger transport vehicle 780. The larger transport vehicle 780 may collect the full larger energy storage devices 770 from more than one transfer facility 760 and may deliver empty larger energy storage devices 775 to more than one transfer facility 760.

According to one embodiment, the transfer facility 760 could store the energy stored in one or more of the larger energy collection/storage devices 770 for future use at potentially higher prices, could utilize the energy to provide energy to the facility (e.g., lights, operations) or may distribute the energy in any number of fashions. For example, the transfer facility 760 could provide energy back to the grid, or could use the energy to charge electric vehicles, mine cryptocurrency or any other manner of monetization. According to one embodiment, one or more of the larger energy collection/storage devices 770 located at the transfer facility 760 could be shipped to locations requiring additional energy. For example, if a natural disaster occurred and access to the grid was not available the one or more of the larger energy collection/storage devices 770 could be shipped thereto to provide temporary power for emergency personnel. By way of another example, if a town was conducting a fair and needed additional energy, or back up energy, the one or more of the larger energy collection/storage devices 770 could be shipped thereto to provide the extra/backup energy required.

According to one embodiment, a plurality of green energy capturing devices and battery packs may be utilized by a single customer, such as a customer with a large fleet of vehicles (e.g., buses, trucks, vans, cars, trains, light-rail). The customer may have an energy collection device located at, for example, a depot where the vehicles are parked when not in use. The customer may use the energy collection device to capture the energy from individual battery packs that are utilized to capture energy from the green energy capturing devices located on the vehicles.

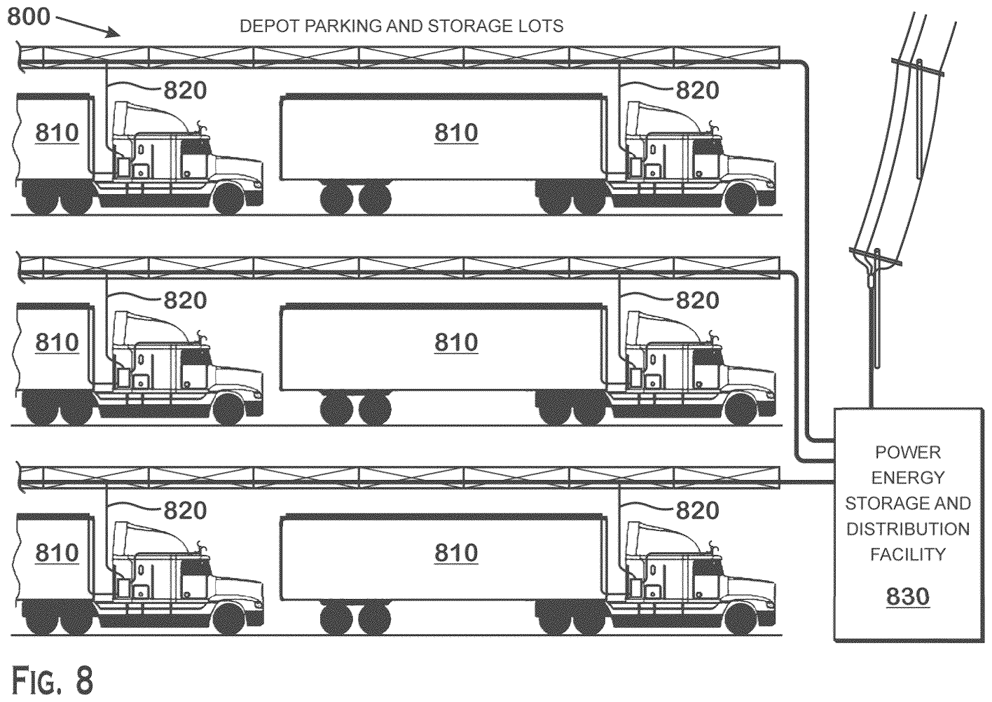

FIG. 8 illustrates an example depot parking and storage lot 800 for tractor trailers 810 that provides cables 820 for discharging the battery packs of the tractor trailers 810. The depot 800 provides the customer the ability to collect their own energy from the individual battery packs into one or more larger energy collection/storage devices 830. The energy collection/storage device can be used (170 of FIG. 1) by the customer to store the energy for future use, to support at least a portion of their electrical needs, or may distribute the energy in some fashion in order to monetize the energy. For example, the customer may provide the energy collected and stored in the one or more larger energy collection/storage devices 830, for example, to a regional facility 780 or to the electric grid. Furthermore, the customer could utilize the energy to provide EV charging, mine cryptocurrency or provide energy to other local businesses. Moreover, one or more of the larger energy collection/storage devices 830 could be shipped to locations requiring additional energy.

The depot would have a contract with the system that defines the appropriate parameters. The depot can use the application to track the amount of energy provided from the battery packs to the energy collection/storage devices 830, the amount of energy stored in the energy collection/storage devices 830 and the amount of energy distributed from the energy collection/storage devices 830 for the various purposes including but not limited to, for operations thereof, transfer to a regional facility 780, other entities, or the grid, or local monetization (e.g., EV charging, cryptocurrency mining).

It should be noted that while the depot parking and storage lot 800 was illustrated for tractor trailers, the same concept can be used for any type of fleet vehicles including, but not limited to, vans, trucks, trains, buses, boats or a combination thereof without departing from the current scope. That is, any customer having a plurality of vehicles with energy capturing devices and energy storage devices located therein could utilize such a system to collect and store their own energy on site and monetize the green energy.

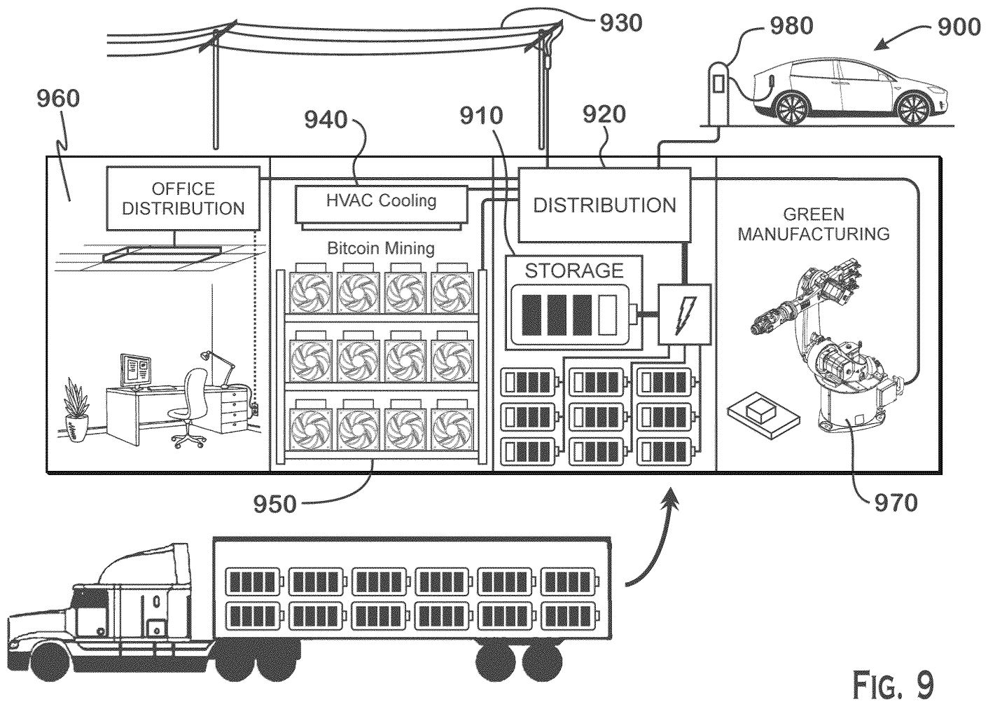

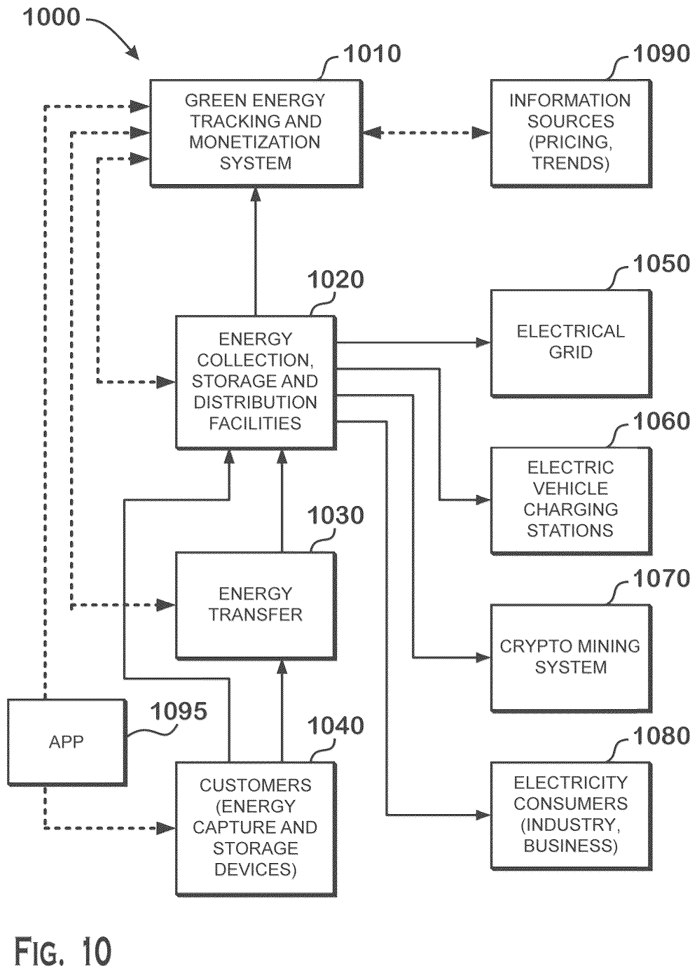

FIG. 9 illustrates an example functional diagram of a regional energy collection facility 900 (e.g., 790 of FIGS. 7A, 7B). The facility 900 receives either full battery packs (e.g., 720 of FIG. 7A) or energy collection/storage devices (e.g., 770 of FIG. 7B) and uploads the energy into an energy collection/storage facility 910. The regional facility 900 may store some portion of the energy captured in the storage facility 910 for future use in hopes of obtaining a higher prices therefore. The regional facility 900 may utilize at least some portion of the energy captured in the storage facility 910 for distribution 920 in order to monetize the energy. For example, the energy may be distributed to various areas including, but not limited to, the grid 930, computing systems utilized for cryptocurrency mining 950, cooling system for cryptocurrency mining 940, office distribution 960, manufacturing 970 and electric vehicle charging 980. As illustrated, many of the uses of the energy are located within the same physical space. The invention is not limited thereto. Rather, the energy may be provided to other locations within close proximity with departing from the current scope.

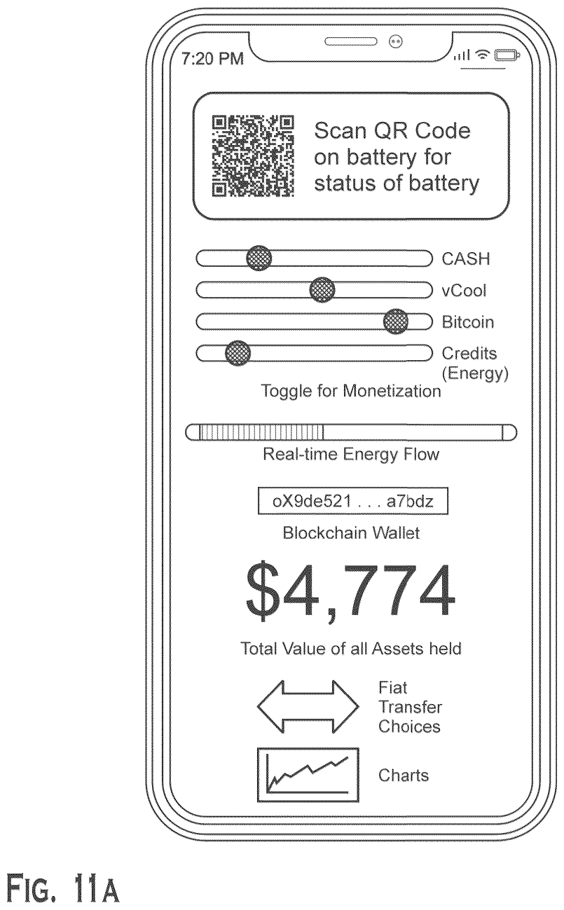

FIG. 10 illustrates a functional block diagram of a green energy harvesting, storage and monetization ecosystem 1000. The ecosystem 1000 includes a green energy tracking and monetization system 1010, one or more energy collection, storage and distribution facilities 1020, one or more energy transfer platforms 1030, and one or more customers utilizing energy collection devices and energy storage devices 1040. The green energy tracking and monetization system 1010 includes a plurality of computers running instructions stored on a computer readable medium that when executed cause the computers to operate the system. For example, the system 1010 is capable of entering smart contracts with the various customers and communicating with the other components of the ecosystem. The communications with the customers 1040 may be via a mobile device application 1095 and may be to associate equipment (e.g., battery packs) with a customer's blockchain/crypto currency wallet, track charging status of batteries, track monetization of energy provided, receive information about energy and cryptoasset prices and trends, and enable toggling of manner in which subscriber is paid.

The energy transfer 1030 includes at least some subset of exchange facilities (e.g., 750 of FIG. 7A), transfer facilities (e.g., 760 of FIG. 7B) and transport vehicles (e.g., 710, 740, 780 of FIGS. 7A-B) to provide the energy captured by the customer 1040 to an energy collection, storage and distribution facility 1020. The energy collection, storage and distribution facility 1020 includes at least some subset of transfer facilities (e.g., 760 of FIG. 7B), depot (800 of FIG. 8) or regional facility (e.g., 790 of FIGS. 7A-B, 900 of FIG. 9). The energy collection, storage and distribution facility 1020 may store energy for future use or distribute the energy to at least some subset of the electric grid 1050, electric vehicle charging stations 1060, cryptomining systems (and the cooling thereof) 1070 and other electricity consumers in close proximity 1080. The system 1010 communicates with the other systems 1020, 1030 to track the receipt and usage of energy provided by the customers 1040.

The system 1010 may also communicate with external information sources 1090 that provide relevant information. For example, the information provided may include pricing information for cryptoassets and energy, as well as trends thereof and predictions therefore. The system 1010 may present that information to the customers via the application 1095. The customers 1040 may utilize the information presented to toggle the manner in which they receive payment. Furthermore, the system 1010 may utilize artificial intelligence to process the external information 1090 as well as internal information to make predictions regarding pricing or the like. The artificial intelligence engine may be part of the system 1010 or the system may utilize an external AI engine.

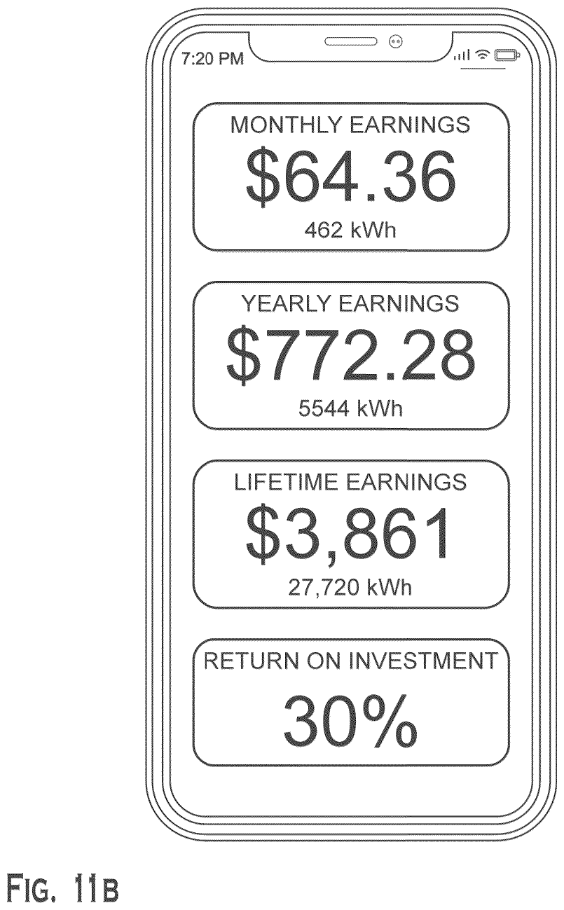

FIGS. 11A-B illustrate example views of a user interface provided by the mobile device application for the system. FIG. 11A illustrates a user interface that enables a customer to scan a QR code to associate a battery pack with their wallet as well as an easy means for toggling the manner in which they will be paid, and provides a value for their assets. FIG. 11B illustrates various parameters regarding the customers' earnings for different periods ad an overall return on investment.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention. As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

1. A renewable/sustainable energy harvesting, storage and monetization system, the system comprising
a plurality of renewable/sustainable energy capturing devices to capture energy;
a plurality of renewable/sustainable energy storage devices coupled to at least one of the plurality of the renewable/sustainable energy capturing devices to store the captured energy;
an energy collection, storage and distribution facility for receiving and storing the captured energy and distributing at least a portion of the stored energy for usage and monetization thereof; and
a green energy tracking and monetization system for entering smart contracts with customers, wherein the customers utilize the plurality of renewable/sustainable energy capturing devices and the plurality of renewable/sustainable energy storage devices, wherein a smart contract for a customer associates appropriate ones of the plurality of renewable/sustainable energy storage devices with an digital asset wallet for the customer and tracks the energy provided to the energy collection, storage and distribution facility and the monetization thereof and provides payment to the customer therefore.

2. The system of claim 1, wherein the energy collection, storage and distribution facility utilizes the stored energy for at least some subset of
cryptocurrency mining;
selling energy to the grid;
charging stations;
industrial applications; and
building power.

3. The system of claim 2, wherein the green energy tracking and monetization system for utilizes the assets acquired from the utilization of the stored energy to pay the customers per the parameters of the contract.

4. The system of claim 1, wherein the one or more renewable/sustainable energy capturing devices include solar panels.

5. The system of claim 4, wherein the solar panels are located on vehicles.

6. The system of claim 5, wherein the vehicles include at least some subset of cars, vans, trucks, buses, trains, and light-rail.

7. The system of claim 1, wherein the one or more renewable/sustainable energy capturing devices include wind turbines.

8. The ecosystem of claim 7, wherein the wind turbines are located on vehicles.

9. The ecosystem of claim 1, wherein the one or more renewable/sustainable energy capturing devices include water turbines.

10. The ecosystem of claim 9, wherein the water turbines are located in locations where excess water flows at certain times.

11. The ecosystem of claim 10, wherein the water turbines are connected to downspouts.

12. The ecosystem of claim 1, the one or more renewable/sustainable energy capturing devices include kinetic energy devices.

13. The ecosystem of claim 1, wherein the one or more energy storage devices includes battery packs.

13. The system of claim 1, further comprising an application running on a wireless device for providing communications between the customer and the green energy tracking and monetization system, wherein the customer uses a camera of the wireless device to scan a code identifying the one or more energy storage devices and the application communicates the code to the green energy tracking and monetization system in order to associate the one or more energy storage devices to the digital asset storage wallet for the customer.

14. The system of claim 1, wherein full renewable/sustainable energy storage devices are exchanged for empty renewable/sustainable energy storage devices.

15. The system of claim 1, wherein energy from full renewable/sustainable energy storage devices is extracted therefrom.

16. The system of claim 1, wherein the customers are paid via some subset of cash, cryptocurrency, crypto asset, or credit.

17. The system of claim 1, wherein the energy collection, storage and distribution facility is operated at least partially by a fleet customer.

18. The system of claim 1, wherein the renewable/sustainable energy storage devices are capable of receiving captured energy from a plurality of the renewable/sustainable energy capturing devices.

19. The system of claim 1, wherein the renewable/sustainable energy storage devices are capable of receiving captured energy from a plurality of the renewable/sustainable energy capturing devices simultaneously.

20. The system of claim 1, wherein energy collection, storage and distribution facility may store the energy for future use at potentially higher prices.
